(19) United States
(12) Patent Application Publication
(10) Pub. No.: US 2017/0175420 A1
(43) Pub. Date: Jun. 22, 2017

(54) LOCKSET ASSEMBLY WITH SELECTIVE OPENING AND CLOSING

(71) Applicant: Te-Yu Chen, Pingtung City (TW)

(72) Inventor: Te-Yu Chen, Pingtung City (TW)

(21) Appl. No.: 14/977,593

(22) Filed: Dec. 21, 2015

(51) Int. Cl. E05B 63/00; E05B 63/16; E05B 13/00; E05B 59/00

(52) U.S. Cl. CPC E05B 63/0065; E05B 59/00; E05B 63/0043; E05B 63/16; E05B 13/002; E05B 2063/0082

(57) ABSTRACT

A lockset assembly with selective opening and closing, which primarily includes a press component, a linking component, a positioning component, a braking component, a sliding component, a connecting rod, a sliding rod, and an arresting rod. The press component is connected to the arresting rod using the linking component and the positioning component. The braking component is installed on one side of a handle shaft of the lockset, and the sliding component is installed on an upper edge of the handle shaft. The sliding component is able to slide along the handle shaft. Accordingly, pressing of the press component causes switching, which causes a displacement of the positioning component and a corresponding arrestment or disengagement of the arresting rod, thereby enabling the lockset to form a state which can be opened with a handle both from inside and outside a room.

### BACKGROUND OF THE INVENTION

(a) Technical Field of the Invention

The present invention relates to a lockset assembly with selective opening and closing, and more particularly to a lockset assembly that enables a lockset to form a locked state which can be opened with a handle from inside and outside a room; after turning into an idle state, the lockset can be in an open state inside a room and locked from outside the room, or the handle can be used to cause the lockset to form a locked arrangement and an idle state; thus achieving the objective of preventing burglary.

(b) Description of the Prior Art

Regarding the use of general locksets, especially when used in rooms including classrooms, meeting rooms, and the like, the lockset must normally be set up to allow for different opening states, such as: enable opening from inside the room, enable opening from outside the room, and so on. However, the setting up of such states in locksets of the prior art is comparatively troublesome, which, due to errors in the settings, often results in not being able to re-enter a room after leaving, bringing about the inconvenience of needing a key to open the lock. Furthermore, because the lockset is in a locked state when locked and not an idle state, if by any chance a burglar wants to illegally enter the locked room, then the burglar usually, after unlocking the lockset using a picklock, he/she turns a handle shaft to open the lockset. However, if the design of the lockset is of high quality, then the burglar will not be able to open the lockset within a short period of time. Therefore, the majority of burglars will forcefully rotate the handle shaft, thereby damaging the lockset and causing the lockset to lose its function to be locked. Hence, traditional locksets are not only unable to stop burglars from opening the locksets, but, for the user, there also exists the anxiety that the lockset will be damaged. In view of this, the applicant. having accumulated years of experience in related arts, following continuous research and experimentation, finally succeeded in producing an improved lockset assembly with selective opening and closing, which enables the lockset to form states which enable opening from inside and outside a room, as well as achieving the objective of preventing burglary.

### SUMMARY OF THE INVENTION

The primary objective of the present invention lies in providing a lockset assembly with selective opening and closing, which enables a lockset to use a simple and easy selective switch-over mechanism to form states which allow the lockset to be opened from both outside a room and inside the room; after turning into an idle state, the lockset can be in an open state from inside a room and locked from outside the room; or a handle can placed in an idle state; thereby achieving the objective of preventing burglary.

The aforementioned lockset assembly with selective opening and closing comprises a press component, a linking component, a positioning component, a braking component, a sliding component, a connecting rod, a sliding rod, and an arresting rod; wherein the press component is connected to the arresting rod using the linking component and the positioning component. The braking component is installed on one side of a handle shaft of the lockset, and the sliding component is installed on an upper edge of the handle shaft, and is able to slide along the handle shaft. Accordingly, pressing of the press component causes switching, which causes a displacement of the positioning component and a corresponding arrestment or disengagement of the arresting rod, thereby enabling the lockset to form a state which can be opened with a handle both from inside and outside a room; after turning into an idle state, the lockset can be in an open state inside a room and locked from outside the room, or the lockset assemble enables forming a locked state from both inside and outside the room; thus further achieving the objective of selective opening and closing.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 and FIG. 1A are structural views of the present invention.

FIG. 2 is an exploded view of the main components of the present invention.

FIG. 3 and FIG. 3A are structural views of a locked state from inside a room and an open state from outside the room according to the present invention.

FIG. 4 and FIG. 4A are structural views of an open state from inside a room and a locked state from outside the room according to the present invention.

FIG. 5 and FIG. 5A are structural views of a turn knob controlled open state from inside a room and an idle state from outside the room according to the present invention.

FIG. 6 and FIG. 6A are structural views of a turn knob controlled open state from inside and outside a room according to the present invention.

### DETAILED DESCRIPTION OF THE PREFERRED EMBODIMENTS

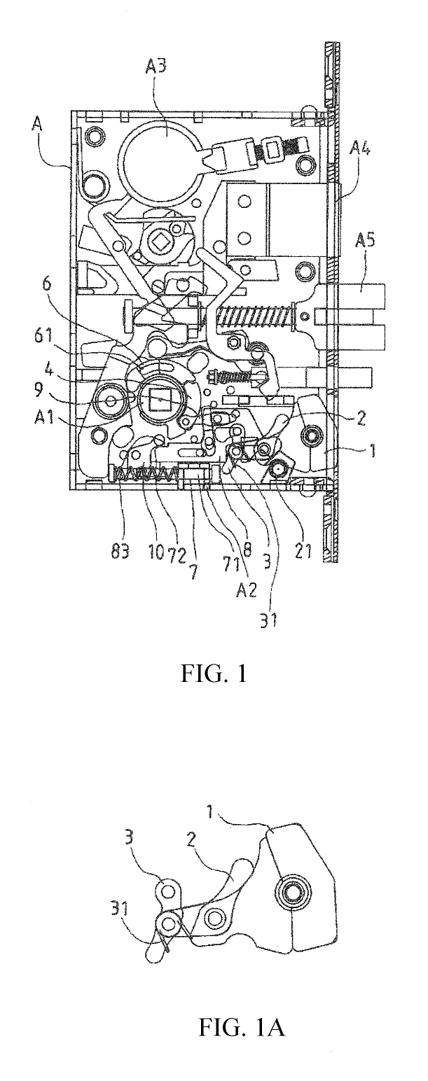

Referring to FIG. 1 and FIG. 1A, which are structural views of the present invention. As shown in the diagrams, the present invention comprises a press component 1, a linking component 2, a positioning component 3, a braking component 4, a swinging component 5, a sliding component 6, a sliding rod 7, an arresting rod 8, a connecting rod 9, and a limiting component 10; wherein the press component 1 is installed in the lower portion of one side of a lockset A, and the press component 1 is connected to the arresting rod 8 using the linking component 2, the positioning component 3, and the connecting rod 9. The lower edge of the press component 1 supportably abuts against an elastic spring 21.

The two ends of the positioning component 3 are circular shaped, with the positioning component 3 being slightly arch shaped. The positioning component 3 is mounted on an elastic spring 31 and connected to the connecting rod 9, thereby enabling the connecting rod 9 to connect to the arresting rod 8.

The braking component 4 is installed on one side of a handle shaft A1 of the lockset A, and the braking component 4 assumes an arch shape. A positioning portion 41 is located at the lower portion of the braking component 4, thereby enabling connection to the swinging component 5.

One end of the swinging component 5 is provided with a fixing portion 51 to enable fixing to the braking component 4, thereby forming a linkage with the braking component 4. A lower edge of the swinging component 5 is provided with a protruding rod 52 to enable clasping to the arresting rod 8.

The sliding component 6 assumes an arch shape. Two sides of the sliding component 6 are respectively provided with wing portions 61 that protrude and extend from the two sides. The wing portions 61 are located on the upper edge of the handle shaft A1, and are able to slide along the handle shaft A1.

The sliding rod 7 is fitted to a positioning piece A2 fitted to the bottom edge of the lockset A. The sliding rod 7 is fitted with a rod body 71, which penetrates and is located within an elastic spring 72.

The arresting rod 8 is installed at the lower portion of the handle shaft A1. A rod portion 81 extends to an appropriate length from the arresting rod 8 and is provided with a protruding portion 82 to enable positioning to the lockset A. One end of the arresting rod 8 is provided with a vertical hook portion 83, and a bottom edge of the arresting rod 8 is provided with a notch 84.

The limiting component 10. is provided with a protruding portion to realize position limiting of the arresting rod 8.

Assemblage of the aforementioned components is used to construct an improved assembly for a lockset. Accordingly, pressing of the press component 1 is used to cause switching, which causes a displacement of the positioning component 3 and a corresponding arrestment or disengagement of the arresting rod 8, thereby enabling the lockset A to form a state which can be opened with a handle both from inside and outside a room; after turning into an idle state, the lockset A can be in an open state inside a room and locked from outside the room; or the lockset A can be enabled to form a locked state from both inside and outside the room; thus further achieving the objective of selective opening and closing.

Referring to FIG. 1 and FIG. 1A, as shown in the diagrams, according to the present invention, when the lower edge of the press component 1 is pressed in, the positioning component 3 is pulled down, but the hook portion 83 of the arresting rod 8 is limited by the limiting component 10, whereupon the braking component 4 and the sliding component 6 mutually clasp. Accordingly, when an external handle is turned, the handle shaft A1 is fixedly clamped by the braking component 4, thereby forming a state enabling the lockset A to be opened from inside a room, with the external handle being in a state disabling turning thereof.

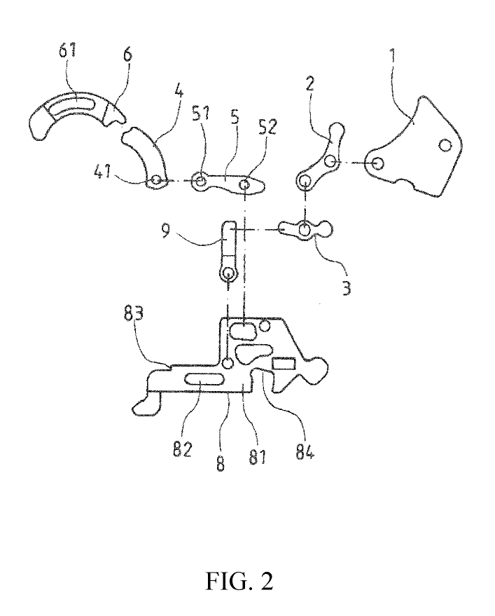

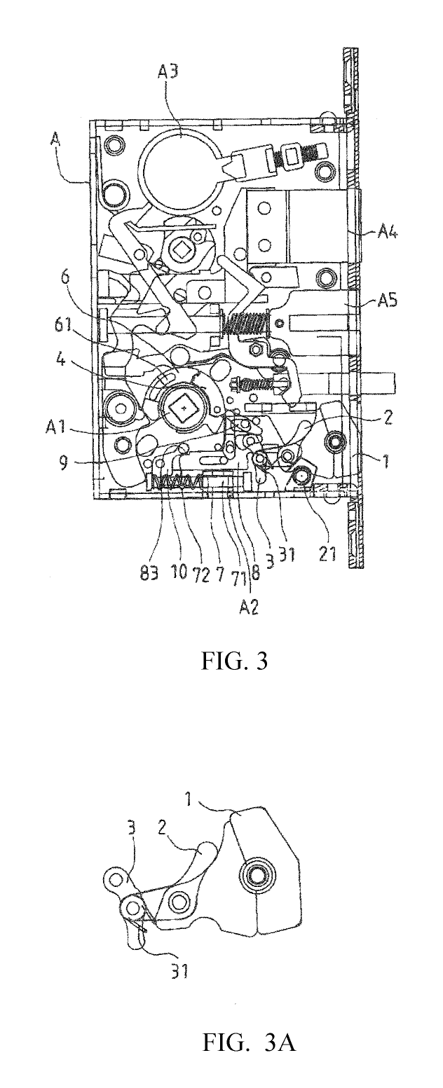

Referring to FIG. 2, FIG. 3 and FIG. 3A, which show structural views of a locked state from inside a room and an open state from outside a room. As shown in the diagrams, according to the present invention, when the upper edge of the press component 1 is pressed in, a lock center A3 is rotated to lock the lockset A, and the positioning component 3 is pressed upward, which correspondingly displaces the arresting rod 8 toward the direction of the press component; whereupon the hook portion 83 disengages from the limiting component 10, and the swinging component 5 pulls down the braking component 4. Accordingly, when the external handle is turned, the handle shaft A1 is impeded by the sliding component 6 and is unable to freely slide, thereby correspondingly disabling the sliding component 6 from pulling a bolt A4 internally, and causing the lockset A to be in a locked state from both inside and outside the room, thus needing a key to open the lockset A.

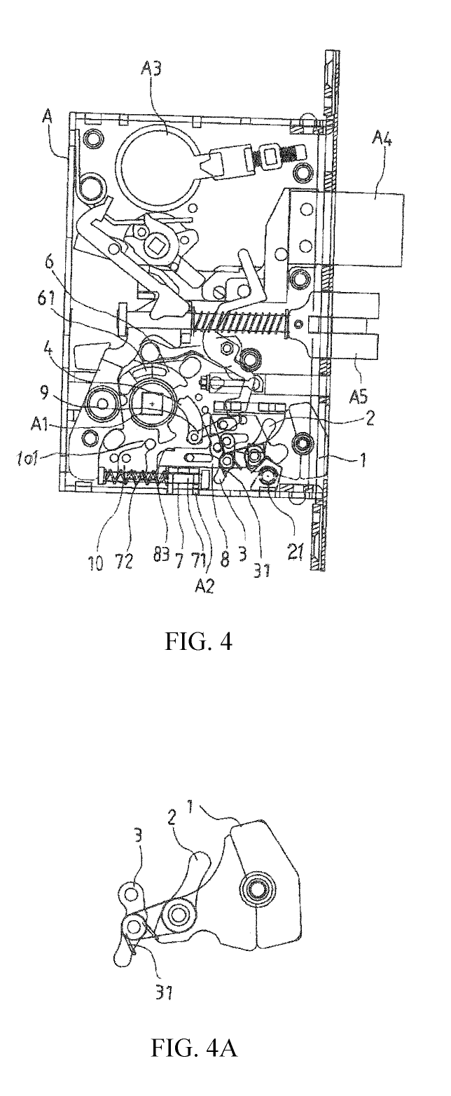

Referring to FIG. 4 and FIG. 4A, which are structural views of an open state from inside a room and an idle state from outside a room. As shown in the diagrams, according to the present invention, when the upper edge of the press component 1 is pressed in, the arresting rod 8 is adjusted and displaced toward the direction of the press component 1, whereupon the positioning component 3 is pulled down and the swinging component 5 pulls down the braking component 4. Accordingly, when the external handle is turned, the handle shaft A1 is impeded by the sliding component 6 and slides on the sliding component 6, thereby correspondingly disabling the sliding component 6 from pulling the bolt A4 internally, and forming a state enabling the lockset A to be opened from inside a room, with the external handle forming an idle state. In such a state, the lockset A forms a pseudo-open state, causing a burglar to mistakenly think that the lockset is already damaged and abandon his attempt to break into the room, thus further achieving the objective of preventing burglary.

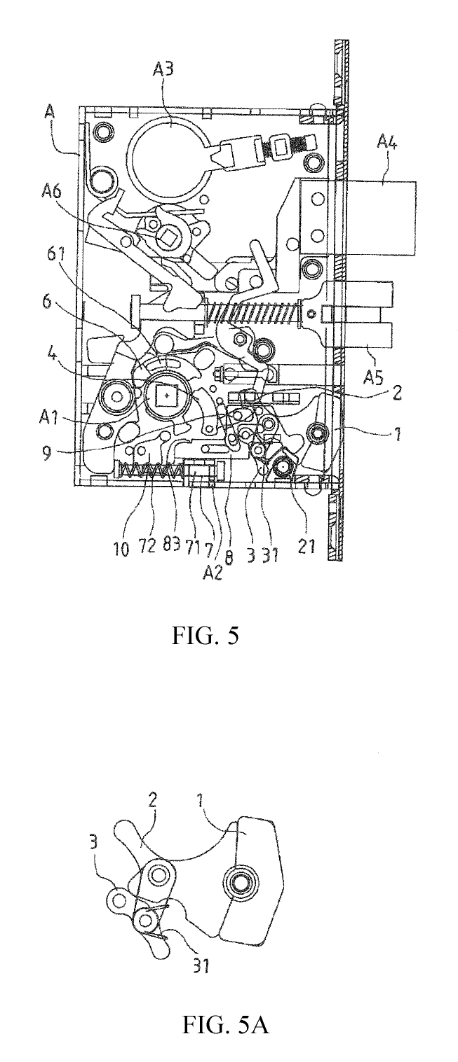

Referring to FIG. 5 and FIG. 5A, which are structural views of a turn knob controlling an open state from inside a room and an idle state from outside the room. As shown in the diagrams, according to the present invention, when the lower edge of the press component 1 is pressed in, the arresting rod 8 is adjusted and displaced toward the direction of the press component 1, whereupon the positioning component 3 is pulled toward the direction of the press component 1, and the swinging component 5 pulls down the braking component 4. Accordingly, when the external handle is turned, the handle shaft A1 is impeded by the sliding component 6 and slides on the sliding component 6, thereby correspondingly disabling the sliding component 6 from pulling the bolt A4 internally, and forming a state enabling the lockset A to be opened from inside a room using a turn knob A6, with the external handle forming an idle state.

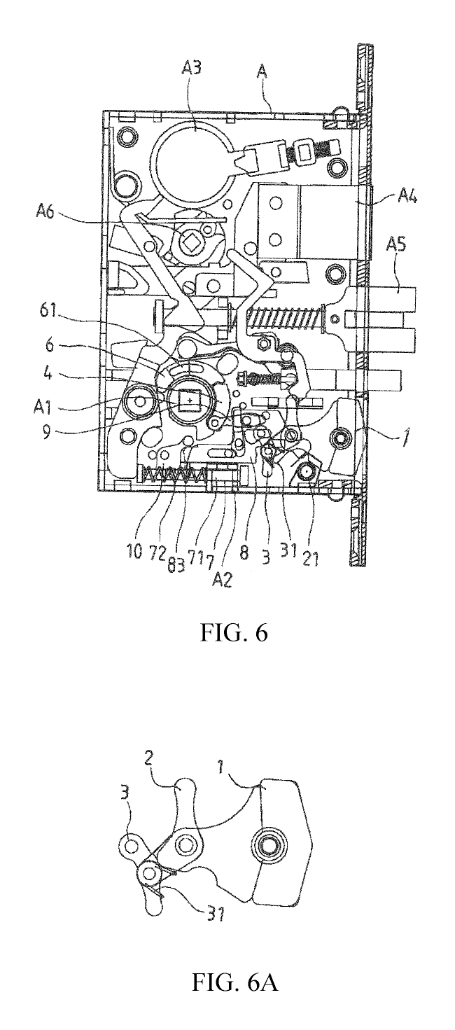

Referring to FIG. 6 and FIG. 6A. which are structural views of the turn knob controlling an open state from inside and outside a room according to the present invention. As shown in the diagrams, according to the present invention, before the press component 1 has been pressed in, and when a bolt A5 is pushed outward, the positioning component 3 is pulled down, which correspondingly displaces the arresting rod 8 toward the relative direction of the press component 1, but the hook portion 83 is limited by the limiting component 10, thus, the braking component 4 and the sliding component 6 mutually clasp, which enables the lockset A to form a state enabling the turn knob A6 to be used to open the lockset A from both inside and outside a room, In conclusion, the present invention comprises a positioning component, a braking component, an arresting rod, a swinging component, a sliding component, and a sliding rod; and uses linkage of the aforementioned components to form a lockset assembly with selective opening and closing. Such a lockset assembly forms a locked state that can be opened with a handle both from inside and outside a room for the convenience of a user to enter and leave the room, or forms a state that can only be opened from inside a room, with the lockset being in an idle state outside the room; and also enables forming a locked state from both inside and outside the room, thus further achieving the objective of selective opening and closing. The present invention provides a practical design for a lockset assembly, and is indeed a novel invention. Accordingly, a new patent application is proposed herein. It is of course to be understood that the embodiments described herein are merely illustrative of the principles of the invention and that a wide variety of modifications thereto may be effected by persons skilled in the art without departing from the spirit and scope of the invention as set forth in the following claims.

I claim:

1. A lockset assembly with selective opening and closing, comprising a press component, a linking component, a positioning component, a braking component, a swinging component, a sliding component, a sliding rod, an arresting rod, and a connecting rod, wherein the press component is installed on a lower portion of one side of the lockset assembly and supportably abuts against an elastic spring; the press component is connected to the arresting rod using the linking component, with the arresting rod connected to the positioning component using the connecting rod, and the positioning component is connected to the connecting rod, thereby enabling the press component to connect to the arresting rod; the braking component is installed on one side of a handle shaft of the lockset; the sliding component is located on an upper edge of the handle shaft, and is able to slide along the handle shaft; the arresting rod is installed to a lower portion of the handle shaft; one end of the swinging component is provided with a fixing portion to enable fixing to the braking component, and thereby form a linkage with the braking component; a lower edge of the swinging component is provided with a protruding rod to enable clasping to the arresting rod; the sliding rod is fitted to a positioning piece installed on a bottom edge of the lockset assembly; the sliding rod is fitted with a rod body, and the rod body penetrates and is located in an elastic spring;
whereby pressing of the press component causes switching, which causes a displacement of the positioning component and a corresponding arrestment or disengagement of the arresting rod, thereby enabling the lockset to form a state which can be opened with a handle both from inside and outside a room; after turning into an idle state, the lockset is in an open state inside a room and locked from outside the room, or the lockset assembly enables forming a locked state from both inside and outside the room; thus further achieving the objective of selective opening and closing.

2. The lockset assembly with selective opening and closing according to claim 1, wherein two ends of the positioning component are circular shaped, and the positioning component is slightly arch shaped.

3. The lockset assembly with selective opening and closing according to claim 1, wherein the braking component is installed on one side of the handle shaft of the lockset and assumes an arch shape; the positioning portion is installed below the braking component.

4. The lockset assembly with selective opening and closing according to claim 1, wherein the arresting rod is installed at the lower portion of the handle shaft; a rod portion extends to an appropriate length from the arresting rod and is provided with a protruding portion to enable positioning to the lockset; one end of the arresting rod is provided with a vertical hook portion.

5. The lockset assembly with selective opening and closing according to claim 1, wherein the sliding rod is fitted to the bottom edge of the lockset, and the sliding rod is provided with a rod body; the rod body penetrates an elastic spring.
